(19) United States
(12) Patent Application Publication
(10) Pub. No.: US 2003/0152418 A1
(43) Pub. Date: Aug. 14, 2003

(54) Filing appliance

(76) Inventor: Peter B Dugmore, Western Cape Province (ZA)

Correspondence Address: WOOD, HERRON & EVANS, LLP, 2700 CAREW TOWER, 441 VINE STREET, CINCINNATI, OH, 45202, US

(21) Appl. No.: 10/296,366

(22) PCT Filed: May 24, 2001
(86) PCT No.: PCT/IB01/00911

(30) Foreign Application Priority Data
May 25, 2000 (ZA) 2000/2607

(51) Int. Cl. B42F 3/00

(52) U.S. Cl. 402/70

(57) ABSTRACT

The invention discloses a transfer device (10) for sheets of material filed in a folder, the transfer device (10) including a base member having a longitudinal axis and a pair of flexible, elongate, transfer (14) members arranged on the base member, the transfer members (14) being displaceable between a stored position wherein they are orientated substantially parallel with the base member and an operative position wherein they extend transversely relative to the base member. The invention is characterised therein in that the transfer members (14) are displaceable between their stored and operative positions about pivot axes (18) which are orientated transversely to the longitudinal axis of the base member. The invention also discloses a file folder having a transfer device (10).

THIS INVENTION relates to the filing of documents. More particularly, this invention relates to a transfer device for a file and to a file folder including a transfer device.

According to a first aspect of the invention, there is provided a transfer device for sheets of material filed in a folder, the transfer device including

a base member having a longitudinal axis; and

a pair of flexible, elongate, transfer members arranged on the base member, the transfer members being displaceable between a stored position wherein they are orientated substantially parallel with the base member and an operative position wherein they extend transversely relative to the base member;

characterised therein that the transfer members are displaceable between their stored and operative positions about pivot axes which are orientated transversely to the longitudinal axis of the base member.

The transfer members may be orientated substantially perpendicularly to the base member when they are in their operative position.

The transfer members may be connected to the base member by integral hinges.

Preferably, the pivot axes of the hinges are orientated transversely to the longitudinal axis of the base member.

The base member may include opposed securing portions for securing it to the inside of a file folder, and a connecting portion extending between the securing portions. The securing portions may include apertures.

The connecting portion is preferably orientated at an angle relative to the longitudinal axis The connecting portion may have a central kink.

It will be appreciated that in this specification and in the appended claims, the term kink refers to a somewhat “S” or “Z” shaped configuration.

Attachment means for attaching the securing portions to the inside of a file cover may be provided.

The attachment means may be securable to a file folder through holes in the folder. The attachment means may alternatively or in addition, be securable to the file folder by way of an adhesive.

The attachment means may be integral with the securing portions. The attachment means may alternatively include clip members which are snugly receivable in the apertures for securing the base member to the file folder.

One or more transfer member retaining formations may be arranged on the base member to which the transfer members may be releasably secured when in their stored position. Alternatively, or in addition, the transfer member retaining formations may be arranged on at least one of the clip members.

According to a second aspect of the invention, there is provided a file folder having secured thereto a transfer device as described above.

One embodiment of this invention will now be described, by way of example, in more detail with reference to the accompanying drawings, in which:

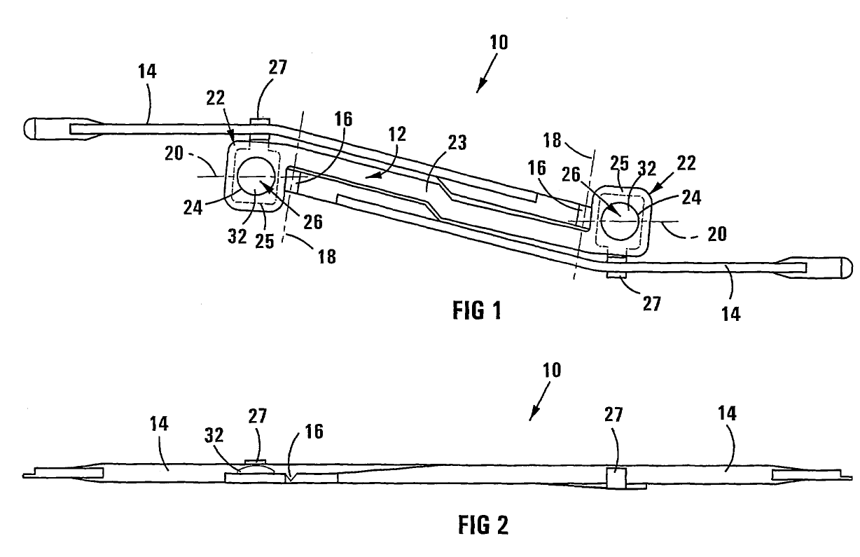

FIG. 1 is a plan view of a transfer device according to the invention with its transfer members in their stored position;

FIG. 2 is a side view of the transfer device of FIG. 1;

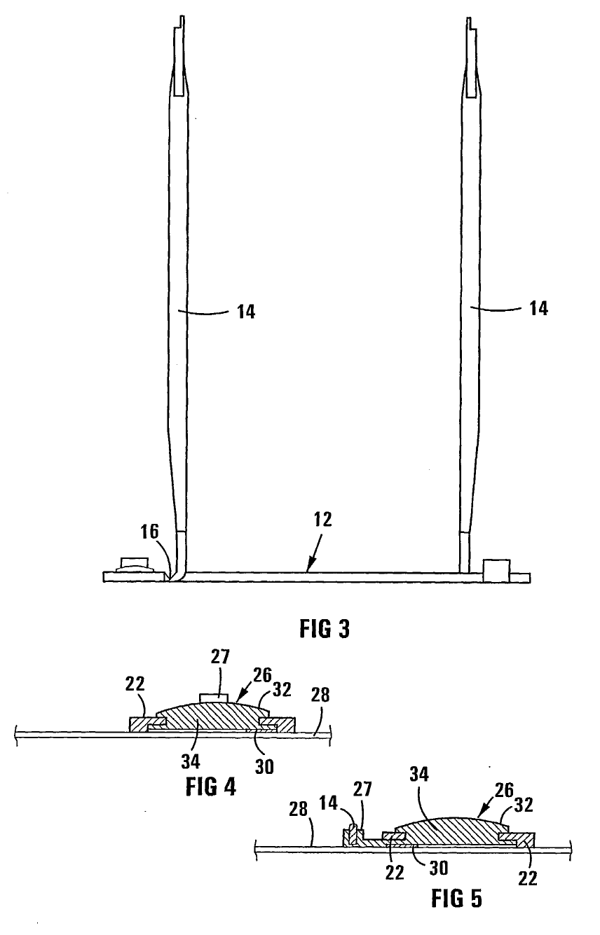

FIG. 3 is a side view of a transfer device according to the invention with its transfer members in their operative position;

FIG. 4 is a sectioned side view of a securing arrangement for the transfer device of FIGS. 1 to 3, showing an associated transfer member retaining formation; and

FIG. 5 is a sectioned end view of the securing arrangement of FIG. 4.

In FIGS. 1, 2, and 3, a transfer device 10 for transferring sheets of material (not shown) in a file (not shown) is shown to comprise an elongate base member 12 having a pair of flexible, elongate transfer members 14 arranged thereon. The base member 12 and the transfer members 14 are manufactured of a plastics material, typically a copolymer propylene. The transfer members 14 are displaceable from a stored position wherein they are orientated substantially parallel with the base member, specifically as shown in FIGS. 1 and 2 and an operative position wherein they are orientated substantially perpendicularly to the base member 12, specifically as shown in FIG. 3. From this position, they may be flexed into a bridged arch (not shown) to facilitate the transfer of sheets of material (not shown), for example, between the opposing inside covers of a file (not shown).

The transfer members 14 are displaceable about integral hinges 16 (most clearly shown in FIG. 3), having pivot axes 18 which are orientated transversely relative to a longitudinal axis 20 of the base member 12.

The base member 12 includes opposed securing portions 22 and a connecting portion 23 (see FIG. 1) which is at an angle to the axis 20 as shown in FIG. 1. Each securing portion 22 includes an aperture 24 and a blind recess 25 (shown in broken lines on FIG. 1) in which a complementary clip member 26 is snugly received. The clip members 26 are made from a substantially rigid plastics material such as ABS. Each clip member 26 defines a head 32 and a base 34 on which base 34 an adhesive, such as a patch of double sided self adhesive tape 30 may be placed in order for the clip members 26 to be adhered to an inner surface of a file cover 28 (see FIGS. 4 and 5). The head 32 of each clip member 26 is dimensioned to fit in a non reversible click fit in the apertures 24 of the securing portions 22 of the base member 12.

As shown in the drawings, each clip member 26 includes a yoke shaped transfer member retaining formation 27 extending laterally from the securing portions 22 and arranged releasably to secure the transfer members 14 when they are in their stored position. The securing action limits floating, i.e. lateral movement of the transfer members thus preventing lateral shear pressure on the integral hinges 16.

In use, the base member 12 is secured to the clip members 26 by pressing the heads 32 of the clip members 26 through the apertures 24, after which the bases 34 of the clip members 26 are adhered to the file cover 28 with prepositioned patches of double sided adhesive tape 30. It will be appreciated that in this way, the entire transfer device 10 lies parallel to the spine (not shown) of the file cover during the assembly operation.

1. A transfer device for sheets of material filed in a folder, the transfer device including
a base member having a longitudinal axis; and
a pair of flexible, elongate, transfer members arranged on the base member, the transfer members being displaceable between a stored position wherein they are orientated substantially parallel with the base member and an operative position wherein they extend transversely relative to the base member;
characterised therein that the transfer members are displaceable between their stored and operative positions about pivot axes which are orientated transversely to the longitudinal axis of the base member.

2. A transfer device as claimed in claim 1 wherein the transfer members are orientated substantially perpendicularly to the base member when they are in their operative position.

3. A transfer device as claimed in claims 1 or 2 wherein the transfer members are connected to the base member by integral hinges.

4. A transfer device as claimed in claim 3 wherein pivot axes of the hinges are orientated transversely to the longitudinal axis of the base member.

5. A transfer device as claimed in any one of claims 1 to 4 wherein the base member includes opposed securing portions for securing it to the inside of a file folder, and a connecting portion extending between the securing portions.

6. A transfer device as claimed in claim 5 wherein the securing portions include apertures.

7. A transfer device as claimed in claims 5 or 6 wherein the connecting portion is orientated at an angle relative to the longitudinal axis.

8. A transfer device as claimed in claim 7 wherein the connecting portion has a central kink.

9. A transfer device as claimed in any one of claims 5 to 8 including attachment means for attaching the securing portions to the inside of a file cover.

10. A transfer device as claimed in claim 9 wherein the attachment means include clip members which are snugly receivable in the apertures for securing the base member to the file folder.

11. A transfer device as claimed in claim 10 wherein the clip members are securable to the file folder through holes in the folder.

12. A transfer device as claimed in claim 10 wherein the clip members are securable to the file folder by way of an adhesive.

13. A transfer device as claimed in any one of claims 1 to 12, including one or more transfer member retaining formations, arranged on the base member, and to which the transfer members are releasably secured when in their stored position.

14. A transfer device as claimed in claim 10, including one or more transfer member retaining formations arranged on at least one of the clip members, which transfer member retaining formations are releasably securable to the transfer members when the transfer members are in their stored position.

15. A file folder having secured thereto a transfer device as claimed in any one of claims 1 to 14.

16. A transfer device substantially as herein described with reference to the accompanying drawings.

17. A file folder substantially as herein described with reference to the accompanying drawings.
